(19) United States
(12) Patent Application Publication
(10) Pub. No.: US 2013/0293883 A1
(43) Pub. Date: Nov. 7, 2013

(54) OPTICAL FIBER FOR OPTICAL SENSING, AND METHOD OF MANUFACTURE THEREOF

(71) Applicant: Agency for Science, Technology and Research, Singapore (SG)

(72) Inventor: Xia Yu, Singapore (SG)

(21) Appl. No.: 13/854,367

(22) Filed: Apr. 1, 2013

(30) Foreign Application Priority Data
Apr. 2, 2012 (SG) 201202408-9

(51) Int. Cl. G01N 21/00; G01N 21/65

(52) U.S. Cl. CPC G01N 21/00; G01N 21/65
USPC 356/301; 385/12; 216/11; 356/446

(57) ABSTRACT

An optical fiber is provided for optical sensing including a core extending along a length of the optical fiber, a cladding surrounding the core, the cladding including a plurality of channels extending along the length of the optical fiber; and a protrusion at a sensing end of the optical fiber, wherein the protrusion has a porous structure and a curved surface. There is also provided a method of manufacturing the optical fiber, a method of optically sensing an analyte, and an apparatus for optical sensing.

### INCORPORATION BY CROSS REFERENCE

This application claims priority from Singapore Application No. SG 201202408-9 filed on 2 Apr. 2012 the entire contents of which are incorporated herein by cross-reference in their entirety.

### FIELD OF INVENTION

The present invention relates broadly to an optical fiber for optical sensing, and a method of manufacture thereof. The present invention also relates to a method of optically sensing an analyte and an apparatus for optical sensing, such as, based on Raman scattering.

### BACKGROUND

Surface Enhanced Raman Scattering (SERS) is a versatile sensing and analytical technique where an analyte is absorbed on to a roughened noble metal surface or onto their colloidal particles, mainly gold (Au) or silver (Ag). Due to the surface plasmonic effect, the analyte molecules experience significant increase in field intensity; hence, the detectable scattering signal also increases several folds. An SERS spectrum of a molecule typically comprises peaks or bands, which uniquely represent a specific set of atomic groups/species present in the respective analyte. This salient feature enables formation of a Raman spectrum of molecules that can represent the analyte's vibrational frequencies and offers a platform for the ‘fingerprint’ characterization.

Incorporation of SERS phenomena along with optical fibers can offer the flexibility for use, e.g., in in-vivo sensing of biological samples. In a SERS sensing system using a conventional optical fiber, the excitation light is coupled into the optical fiber from one end (the measuring end) while the sample (analyte) enters the optical fiber at the other end (the probing end). The excitation light propagates in the optical fiber and interacts directly with the analyte collected at the probing end. The SERS signal scattered by the sample propagates through the optical fiber back to the measuring end, and is directed towards the Raman spectrometer through a fiber coupler and an objective lens.

However, a problem with the above conventional fiber-based SERS system is the small surface area available at the probing end of the optical fiber on which the analyte can be collected for interaction between the laser light. Thus, high laser power and long integration times are often required to achieve high sensitivity for sensing. It will be appreciated that fiber-based SERS system is described merely as an example, and other types of fiber-based sensing systems such as fiber-based absorption sensors, fluorescence sensors also experience similar problems.

A need therefore exists to provide an optical fiber for sensing that seeks to address at least the above-mentioned problem to enhance sensing signal detection.

### SUMMARY

According to a first aspect of the present invention, there is provided an optical fiber for optical sensing comprising:

a core extending along a length of the optical fiber;

a cladding surrounding the core, the cladding comprises a plurality of channels extending along the length of the optical fiber; and

a protrusion at a sensing end of the optical fiber,

wherein the protrusion has a porous structure and a curved surface.

Preferably, the protrusion is formed by etching the sensing end of the optical fiber.

Preferably, the protrusion comprises a plurality of micro-sized or nano-sized structures extending substantially throughout the protrusion, thereby resulting in voids being present between said micro-sized or nano-sized structures and forming the porous structure.

Preferably, said micro-sized or nano-sized structures comprise flake-like structures densely packed across the curved surface of the protrusion.

Preferably, the voids are in communication with the core and the channels for allowing an excitation light received through the core to reach the voids in the protrusion and for allowing a sensing signal to travel from the voids through the core and/or the channels for analysis.

Preferably, the protrusion has a generally spherical shape.

Preferably, the optical fiber is a photonic crystal fiber.

Preferably, a portion of the optical fiber adjacent or proximal to the sensing end is tapered so as to partially collapse the air holes at said portion.

Preferably, at least the protrusion is coated with a noble metal.

According to a second aspect of the present invention, there is provided a method of manufacturing an optical fiber for optical sensing, the method comprising:

providing an optical fiber having a core extending along a length of the optical fiber and a cladding surrounding the core, the cladding comprises a plurality of channels extending along the length of the optical fiber; and

forming a protrusion at a sensing end of the optical fiber,

wherein the protrusion has a porous structure and a curved surface.

Preferably, said forming a protrusion comprises etching the sensing end of the optical fiber.

Preferably, said etching comprises immersing the sensing end of the optical fiber in an etching solution for a period of between about one to two minutes.

Preferably, the protrusion comprises a plurality of micro-sized or nano-sized structures extending substantially throughout the protrusion, thereby resulting in voids being present between said micro-sized or nano-sized structures and forming the porous structure.

Preferably, said micro-sized or nano-sized structures comprise flake-like structures densely packed across the curved surface of the protrusion.

Preferably, the voids are in communication with the core and the channels for allowing an excitation light received through the core to reach the voids in the protrusion and for allowing a sensing signal to travel from the voids through the core and/or the channels for analysis.

Preferably, said forming a protrusion comprises forming the protrusion having a generally spherical shape.

Preferably, the optical fiber is a photonic crystal fiber.

Preferably, the method further comprises tapering a portion of the optical fiber adjacent or proximal to the sensing end to partially collapse the air holes at said portion.

Preferably, the method further comprises cleaving the optical fiber at a point along the tapered portion, and said forming a protrusion comprises etching the cleaved end of the optical fiber to form the protrusion.

Preferably, the method further comprises coating at least the protrusion with a noble metal.

According to a third aspect of the present invention, there is provided a method of optically sensing an analyte of interest, comprising:

providing an optical fiber for optical sensing, the optical fiber comprising:
a core extending along a length of the optical fiber;
a cladding surrounding the core, the cladding comprises a plurality of channels extending along the length of the optical fiber; and
a protrusion at a sensing end of the optical fiber,
wherein the protrusion has a porous structure and a curved surface,

directing the protrusion at the sensing end of the optical fiber to the analyte for collecting the analyte on the protrusion;

coupling light through the core of the optical fiber and the voids of the protrusion to reach the analyte;

evaluating the analyte based on a signal scattered by the analyte received through the core and/or channels in response

Preferably, the method of optically sensing is based on Raman scattering.

According to a fourth aspect of the present invention, there is provided an apparatus for optical sensing comprising a probe, wherein the probe includes an optical fiber comprising:

a core extending along a length of the optical fiber;

a cladding surrounding the core, the cladding comprises a plurality of channels extending along the length of the optical fiber; and

a protrusion at a sensing end of the optical fiber,

wherein the protrusion has a porous structure and a curved surface.

Preferably, the apparatus is based on Raman scattering.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1A is a schematic diagram showing a side view of an optical fiber configured for optical sensing according to an exemplary embodiment of the present invention;

FIG. 1B shows an image of the optical fiber according to the exemplary embodiment taken from a side view;

FIG. 1C shows a schematic cross-sectional view of the optical fiber taken along the line A-A;

FIG. 2A shows an image of the protrusion of the optical fiber taken under a Scanning Electron Microscope (SEM);

FIG. 2B shows a further enlarged view of a section of the protrusion taken under the SEM;

FIG. 3A depicts an image of the protrusion with a cut-out portion to show its internal porous structure;

FIG. 3B is a further enlarged view of a section of the cut-out portion;

FIGS. 4A to 4E depict a method of manufacturing the optical fiber according to an exemplary embodiment of the present invention;

FIG. 5A depicts a schematic side view of the optical fiber provided in a first step of manufacture;

FIG. 5B depicts a schematic cross-sectional view of the optical fiber provided in the first step of manufacture;

FIG. 6A depicts a schematic side view of the optical fiber after being shrunk at a portion thereof in a second step of manufacture;

FIG. 6B depicts an image of a side view of the optical fiber after being shrunk at a portion thereof in the second step of manufacture;

FIG. 7 depicts a schematic side view of the optical fiber after being cleaved at a point along the tapered portion in a third step of manufacture;

FIG. 8A depicts a schematic side view of the optical fiber having a protrusion formed thereon in a fourth step of manufacture;

FIG. 8B depicts an image of the side view of the optical fiber having a protrusion formed thereon;

FIG. 8C shows images of two sample optical fibers in an experiment to illustrate the growth of the protrusion;

FIG. 9A depicts a schematic side view of the optical fiber after the tapered region and protrusion have been coated with gold in a fifth step of manufacture;

FIG. 9B depicts an image of protrusion coated with gold via DC sputtering;

FIG. 9C depicts an image of protrusion coated with gold via e-beam evaporation;

FIG. 10 depicts an apparatus for optical sensing according to an exemplary embodiment of the present invention;

FIG. 11 depicts a method of optically sensing an analyte of interest according to an exemplary embodiment of the present invention;

FIG. 12 depicts a SERS spectrum of an analyte measured using the optical fiber according to an exemplary embodiment of the present invention.

### DETAILED DESCRIPTION

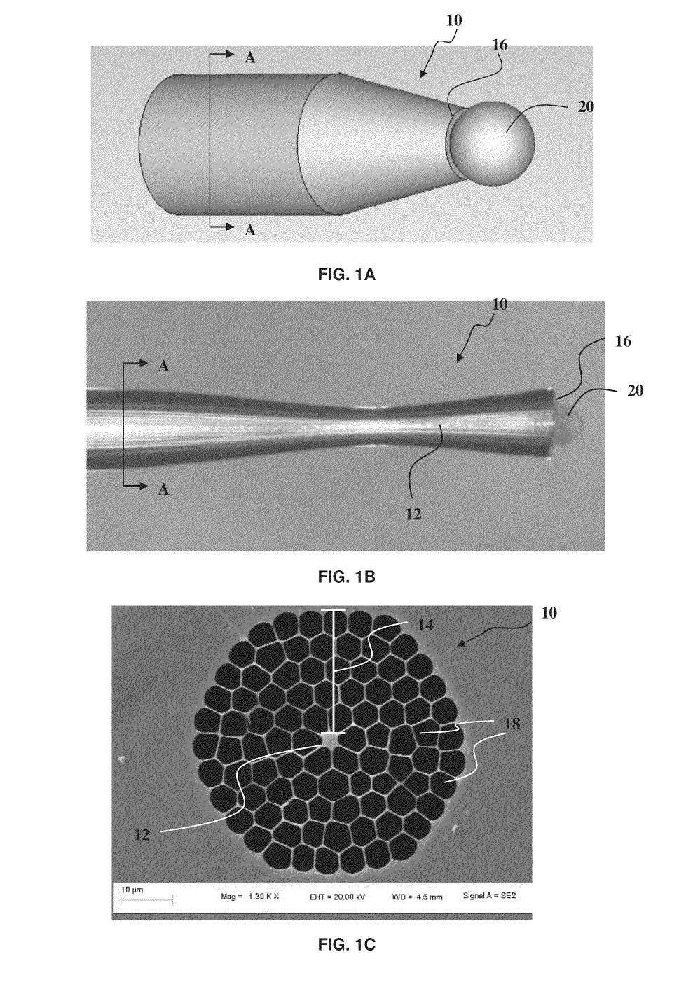

FIG. 1A depicts a schematic diagram showing a side view of an optical fiber 10 configured for optical sensing according to an exemplary embodiment of the present invention. FIG. 1B shows an image of the optical fiber 10 according to the exemplary embodiment taken from a side view. FIG. 1C shows a schematic cross-sectional view of the optical fiber 10 taken along the line A-A shown in FIGS. 1A and 1B.

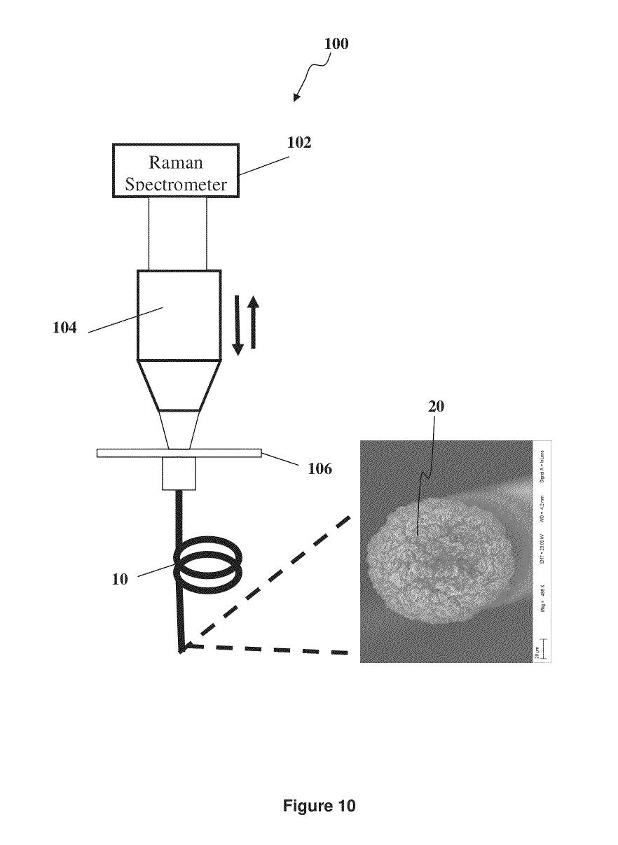

The optical fiber 10 comprises a core 12 extending along the length of the optical fiber 10 and a cladding 14 surrounding the core 12. The core 12 is configured to receive excitation laser light at one end of the optical fiber 10 coupled to a light source (not shown), and to propagate the received light to the other end (the probing or sensing end) 16 of the optical fiber 10. It will be appreciated to a person skilled in the art that although a solid core is shown in FIG. 10, the present invention is not limited to a solid core optical fiber and other types of optical fiber, such as a hollow core type, can also be used. As best illustrated in FIG. 10, the cladding 14 comprises a plurality of air holes or channels 18 surrounding the core 12. The channels 18 extend along the length of the optical fiber 10. It will be appreciated to a person skilled in the art that there are a great variety of channel arrangements for various purposes, and the present invention is not limited to the channel arrangement as shown in FIG. 10, which is merely an exemplary illustration. In a preferred embodiment, the optical fiber 10 is a photonic crystal fiber (PCF). The optical fiber 10 further comprises a protrusion (protruding member) 20 at the sensing end 16 of the optical fiber 10. The protrusion 20 is configured to collect or absorb an analyte (sample) of interest for analysis through optical sensing. The protrusion 20 will now be described in detail.

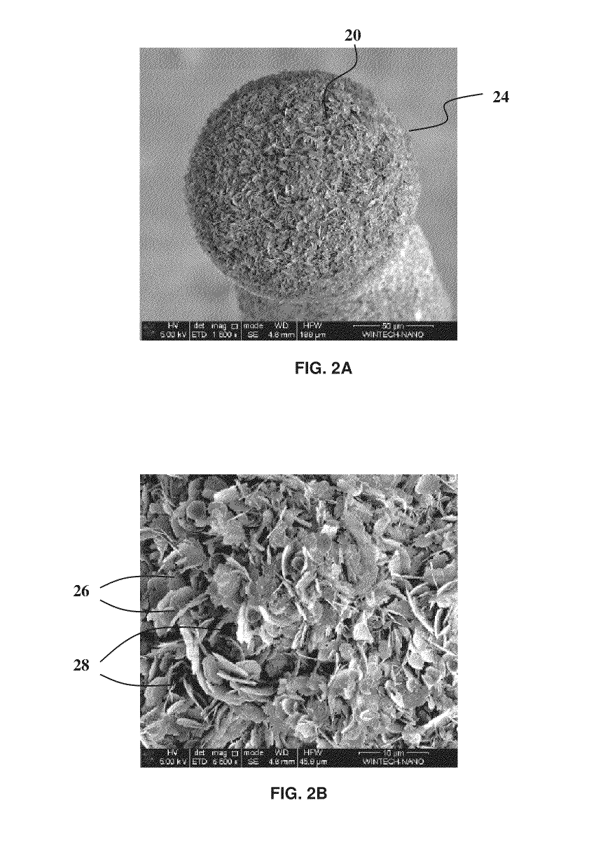

FIG. 2A shows an image of the protrusion 20 the exemplary embodiment captured under a Scanning Electron Microscope (SEM). FIG. 2B shows a further enlarged view of a section of the protrusion 20 taken under the SEM. As shown, the protrusion 20 has a porous structure and a curved surface 24. The porous structure 22 advantageously allows the excitation laser light received in the core 12 from a light source to reach substantially throughout the protrusion 20. Therefore, the excitation laser light is able to reach the analyte collected or absorbed on the protrusion 20 for analysis through optical sensing. In a preferred embodiment, the protrusion 20 has a generally spherical shape as shown in FIG. 2A. In other embodiments, the protrusion 20 may be of any shape as long as it bulges out from the sensing end 16 of the optical fiber 10 with a curved surface 24. For example, the protrusion 20 may be generally bulbous or globated, having a substantially curved or rounded cross-section. It will be understood by a person skilled in the art that a generally spherical shape does not require the shape to be entirely spherical. For example, the protrusion 20 as shown in FIG. 1B would be understood to be generally spherical in shape even though a portion of the protrusion 20 joined to the sensing end 16 of the optical fibre 10 appears flat.

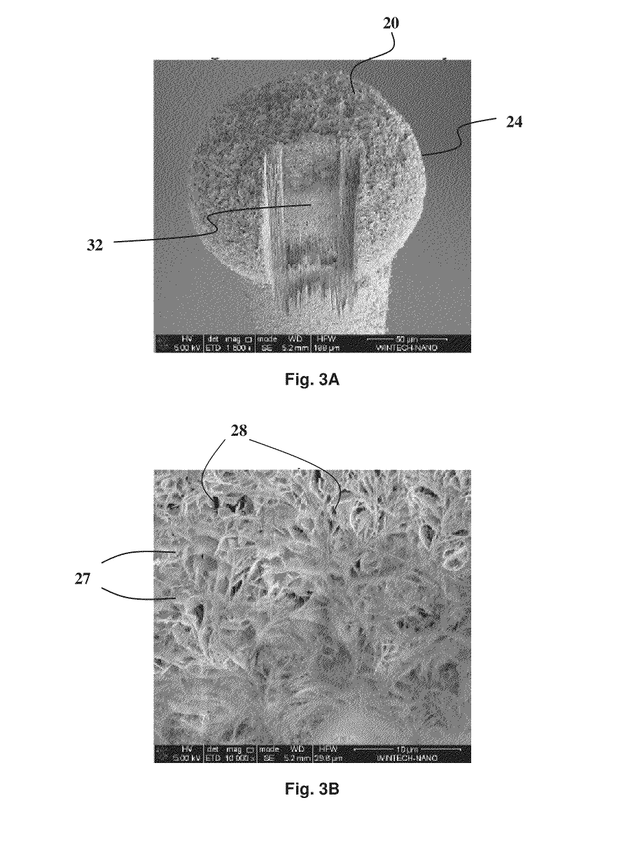

In a preferred embodiment, the protrusion 20 comprises a plurality of flake-like structures 26 on its surface 24 as shown in FIG. 2B and a plurality of web-like structures 27 therein as shown in FIG. 3B. These flake-like structures 26 and web-like structures 27 are micro-sized or nano-sized structures. As shown in FIGS. 2A and 2B, the flake-like structures 26 are densely packed across the surface 24 of the protrusion 20. FIG. 3A depicts an image of the protrusion 20 (taken with 37 micrometer rastering using focus ion beam (FIB)) having a cut-out portion 32 in order to show its internal structure. FIG. 3B is an enlarged view of a section of the cut-out portion 32. As shown in FIG. 3B, the protrusion 20 is porous with the web-like structures 27 extending substantially therein. Due to the web-like structures 27 and flake-like structures 26, voids or cavities 28 are present throughout the protrusions 20 thus forming the porous structure. The voids 28 are in communication with the core 12 and the channels 18 for allowing the excitation light received through the core 12 to reach the voids 28 in the protrusion 20 and for allowing a sensing signal from the voids 28 to travel through the core 12 and/or the channels 18 for optical sensing.

The above structure or characteristics of the protrusion 20 advantageously results in an unusually high surface area-to-volume ratio. Therefore, a larger surface area is provided for analyte to be collected thereon for interaction with the excitation laser light. This advantageously enhances sensing signal detection and meets the needs of various industrial applications for optical sensing, for example, the need for highly efficient probes or sensors in surface enhanced Raman spectroscopy (SERS) systems.

In a preferred embodiment, the composition of the protrusion 20 is substantially of the same material. In particular, the device is advantageously made of silica alone with minimal or no impurities. A method 40 of fabricating the optical fiber 10 for optical sensing will now be described in detail according to an exemplary embodiment of the present invention.

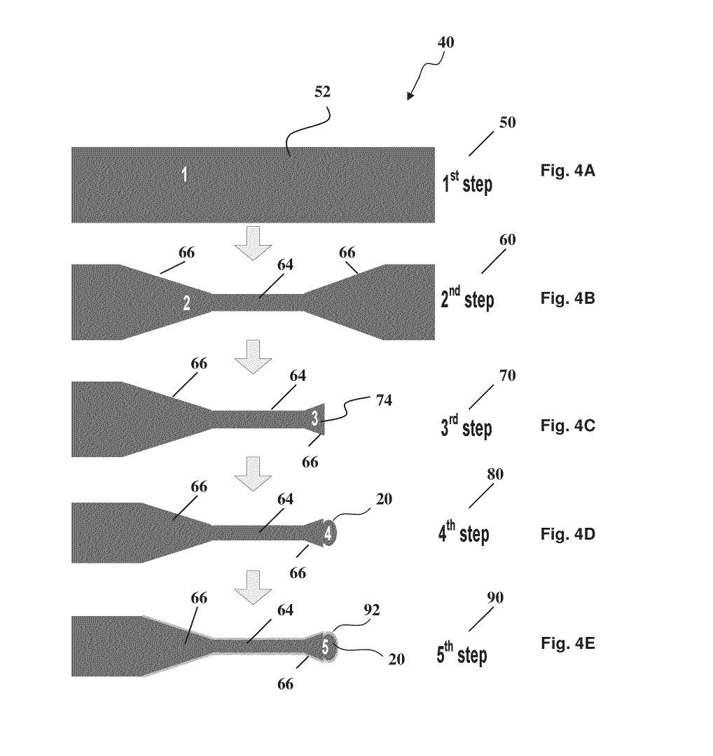

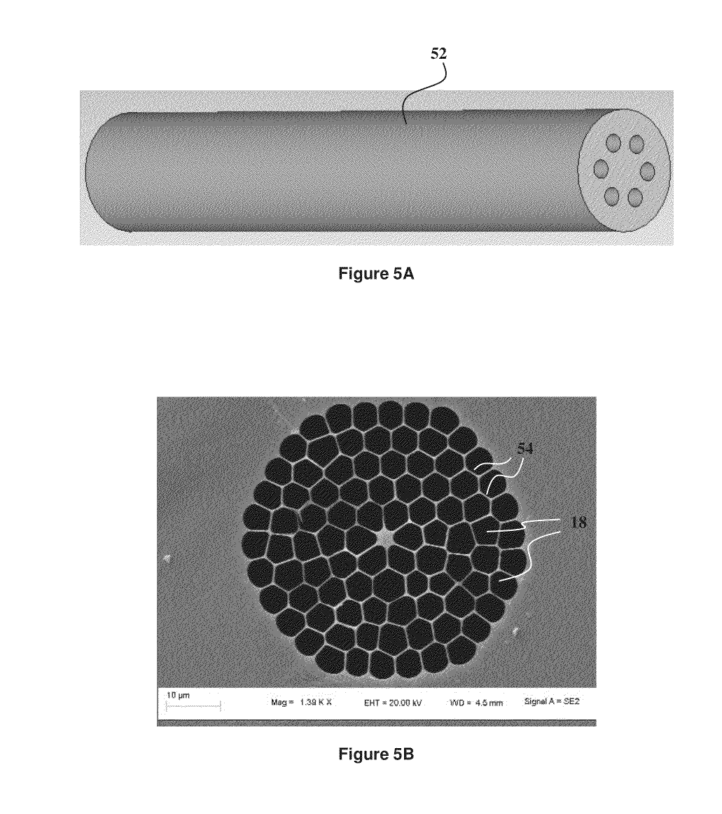

As a first step 50, an optical fiber 52, preferably a photonic crystal fiber (PCF), is provided as shown in FIGS. 4A and 5A. The optical fiber 52 may be one commercially available, or it may a specifically design one with a desired number of channels 18 and arrangement thereof in the cladding 14 for various purposes, such as to achieve a desired effect (e.g., density and/or shape) on the micro/nano-structures produced in the protrusion 20. For example, larger number of channels 18 arranged closely together has been found to produce denser micro/nano-structures throughout the protrusion 20, thus achieving higher surface area-to-volume ratio. As a non-limiting example, a PCF 52 is provided having a cross-section as shown in FIG. 5B. In particular, the channel 18 has a diameter of about 4.0 μm, a channel-to-channel distance of about 3.8 μm, and a bridge 54 between adjacent channels 18 of about 200 nm. The optical fiber 52 will typically have a protective polymer coating or jacket. If so, the polymer jacket is stripped off and the uncoated optical fiber 52 is cleaned using, for example, ethanol.

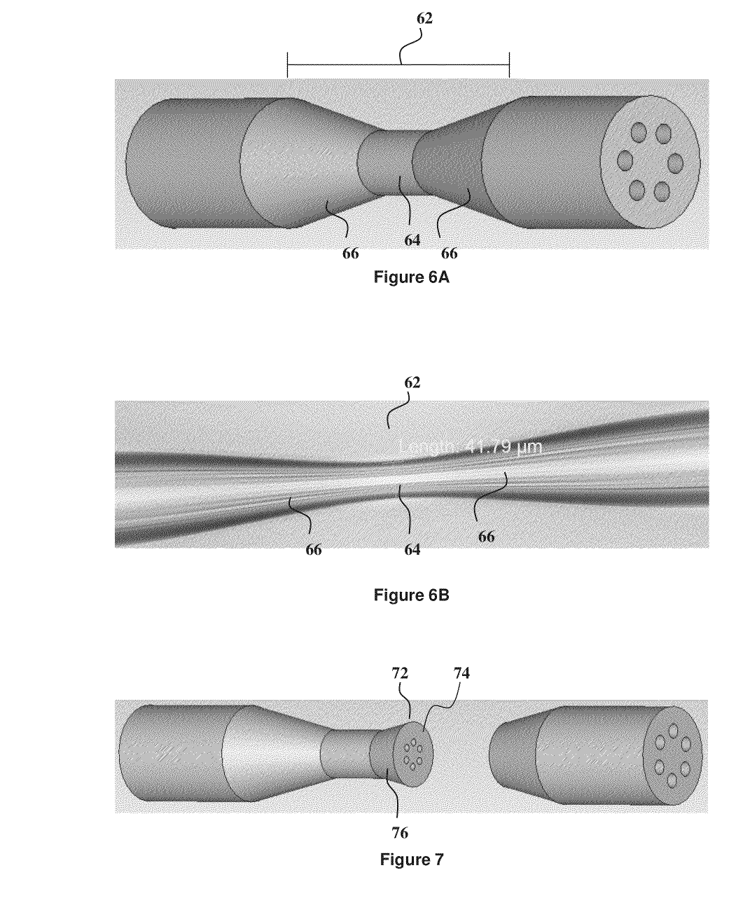

In a second step 60, as shown in FIGS. 4B and 6A, a portion of the optical fiber 52 is shrunk or narrowed resulting in a waist portion 62 having a narrowed portion 64 between two opposing tapered regions 66. During this step, the channels 18 in the waist portion 66 partially collapse but remain open. This advantageously prevents or at least minimises the flow of etching solution through the channels 18 via capillary action when the sensing end 16 of optical fiber 52 is being etched (to be described later). By way of example, a portion of the optical fiber 52 may be shrunk using a fusion splicer unit (FSU) 995 PM made commercially available by Ericsson. An image of the optical fiber 52 having a waist portion 62 is shown in FIG. 6B.

In a third step 70, as shown in FIGS. 4C and 7, the optical fiber 52 is cleaved at a point 72 along the tapered portion 66 and the cleaved end 74 becomes the sensing end 16 of the optical fiber 52. By way of example, a commercially available ultrasonic fiber optic cleaver (FK11-STD) may be used to cleave the optical fiber 52. For example, the optical fiber 52 may be cleaved at a point 72 along the tapered portion 64 about 60 um from the proximal end of the narrowed portion 64.

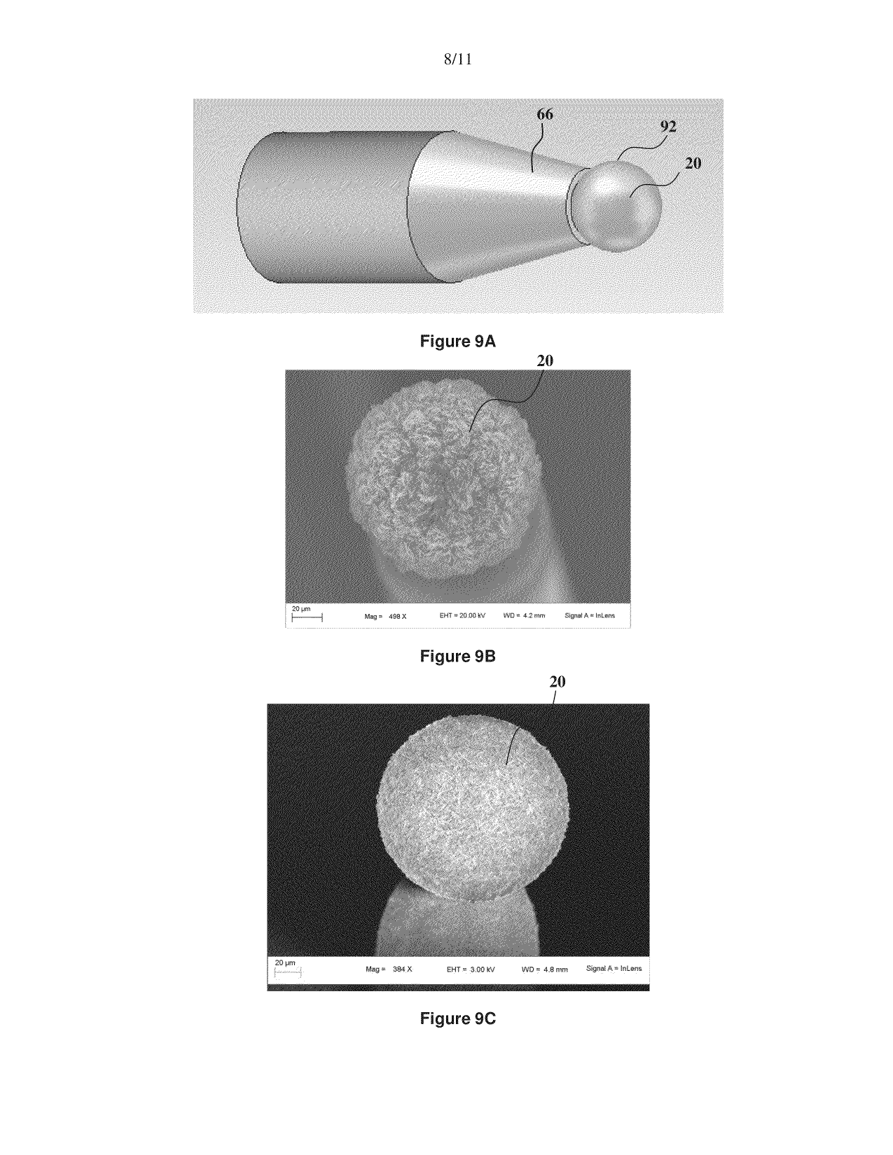

In a fourth step 80, the cleaved tapered portion 76 is chemically etched to form or grow the protrusion 20. In particular, the cleaved tapered portion 76 of the optical fiber 52 is immersed in an etching solution for a predetermined period of time. By way of example only, the cleaved tapered portion 76 may be immersed in a 10% concentration hydrofluoric (HF) acid for a period of about one to two minutes. As a result of the etching, it was observed that the diameter of the cleaved tapered portion 76 was reduced with its sharp edges being etched off. At the same time, a protrusion 20 is observed to form at the cleaved end 74 of the optical fiber 52 as shown in FIGS. 4D and 9B. The protrusion 20 of the optical fiber 52, as well a portion of the optical fiber 52 close to the protrusion 20, is then immersed in e.g., KOH solution for acid-base neutralisation. Preferably, the whole optical fiber 52 including the protrusion 20 formed thereon is then washed with de-ionised water.

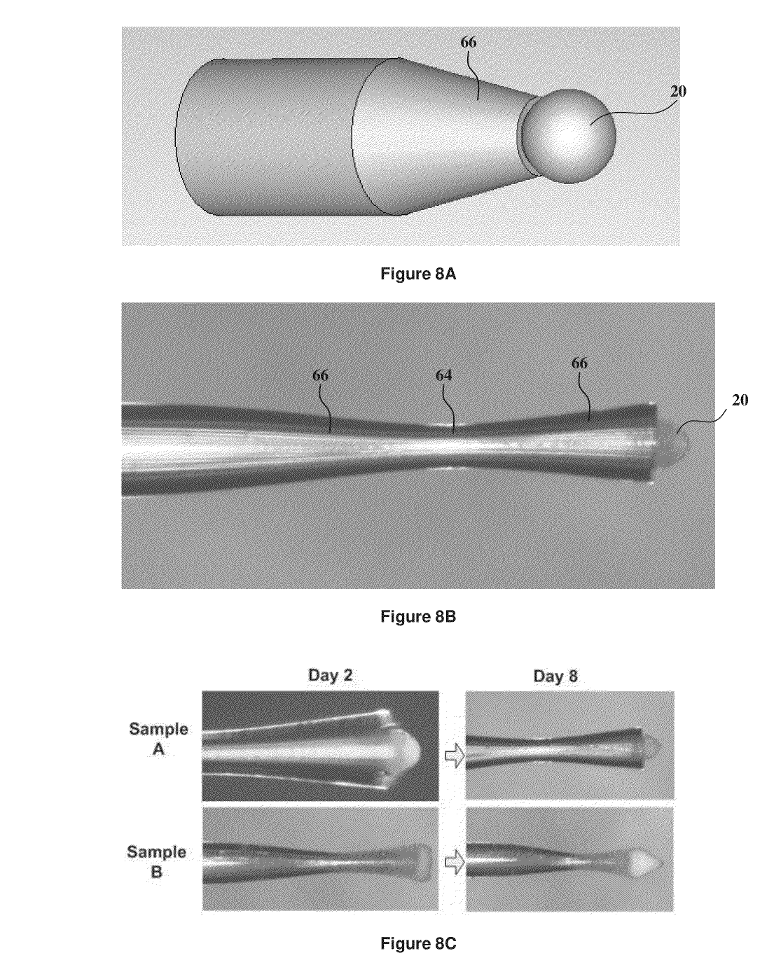

According to an embodiment, the etching period is controlled to avoid over-etching as well as to influence the shape of the resultant protrusion 20. In an experiment, Samples A and B (both PCFs) were subjected to an etching solution (HF acid) for one minute and two minutes respectively as shown in FIG. 8C. In the experiment, it was observed that the protrusions appeared immediately or soon after the etching step in both Samples. Images of Samples A and B taken under a microscope on the second day and the eighth day after etching are shown in FIG. 8C. With Sample B, on the eighth day, it was observed that the fiber tip (i.e., cleaved tapered portion 76) was nearly etched off. From a closer look at the fiber tip, it was noted that a tiny amount of residue etching solution or acid remained in the channels 18 of the optical fiber 52. This suggests that a very slow etching process continues even after the optical fiber 52 was flushed with de-ionised water. This experiment shows that the optical fiber 52 of Sample B was over-etched. Therefore, the etching period is preferably less than two minutes according to an embodiment of the present invention. More preferably, the etching period is between about one to two minutes. In addition, it can be observed that the shape of the protrusion 20 of Samples A and B are different. In particular, Sample A has a more rounded protrusion and Sample B has a pointier or candle flame shaped protrusion.

Regarding the formation of the protrusion 20, an explanation is that the chemical etching process applies a positive pressure to the inner surface of the channels 18 of the optical fiber (i.e., PCF) 10, which results in debris being pushed out to the open space (i.e., the cleaved end 74 of the optical fiber 52). Thus, a protrusion 20 bulges out from the tip of the optical fiber 10, advantageously having a porous structure as well as a plurality of flake-like structures 26 on its surface 24 resulting in a high surface area-to-volume ratio.

In a fifth step 90, as shown in FIGS. 4E and 9A, the protrusion 20 (and optionally a portion of the optical fiber 52 close to the protrusion 20, such as the waist portion 52) is coated with a noble metal, such as gold, silver, platinum or copper, to introduce the surface enhancement effect. By way of example only, a gold coating 92 of 50 nm thickness is applied to the protrusion 20 by various techniques known in the art. FIGS. 9B and 9C illustrate a 50 nm gold coating applied the protrusion 20 via DC sputtering and e-beam evaporation techniques, respectively. Nanostructure with extremely large surface areas can be observed from FIGS. 9B and 9C.

Advantageously, the fabrication of the protrusion 20 can be performed without stringent fabrication environment, for example, without clean room conditions.

The optical fiber 10 according to the exemplary embodiments of the present invention has a wide range of applications such as in apparatuses for the detection, identification or classification of unknown substances based on various forms of spectroscopy. For example, the optical fiber 10 may be used as a probe in a sensing apparatus for the analysis of analyte based on the absorption and/or emission spectra produced by illuminating the analyte via the optical fiber 10 to determine a spectral “fingerprint” of the analyte.

FIG. 10 illustrates a Surface-enhanced Raman spectroscopy (SERS) sensing apparatus 100 incorporating the optical fiber 10 according to an exemplary embodiment of the present invention as an example application. SERS sensing apparatus is known in the art and need not be described in detail. The main difference between the SERS sensing apparatus as shown in FIG. 10 and a conventional SERS sensing apparatus is the replacement of the conventional optical fiber with the optical fiber 10 according to exemplary embodiments of the present invention. By way of example, the SERS sensing apparatus 100 comprises a Raman spectrometer 102 for emitting an excitation laser light to the optical fiber 10 for illuminating the analyte on the protrusion 20 and for receiving and analysing the Raman signal scattered by the analyte to detect or identify the analyte or its structure. The SERS sensing apparatus 100 further comprises an adjustable objective lens 104 and a fiber coupler 106.

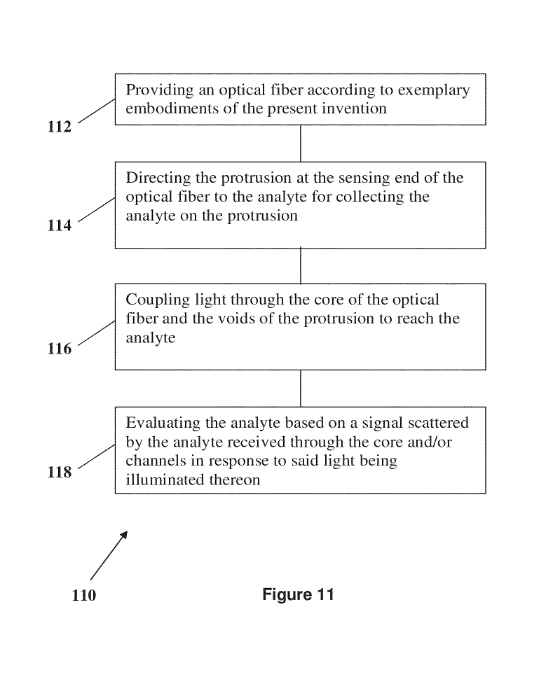

FIG. 11 depicts a flow chart 110 illustrating a method for sensing an analyte such as biological samples according to an example embodiment. As a first step 112, an optical fiber 10 according to exemplary embodiments of the present invention is provided. At a second step 114, the protrusion 20 at the sensing end of the optical fiber 10 is directed to an analyte of interest for collecting the analyte on the protrusion 20. At a third step 116, light is coupled through the core of the optical fiber 10 and the voids of the protrusion to reach the analyte. Then as a fourth step 118, the analyte is evaluated based on a signal scattered by the analyte received through the core and/or channels in response to the light illuminated thereon. For example, this method may be applied to in-vivo sensing.

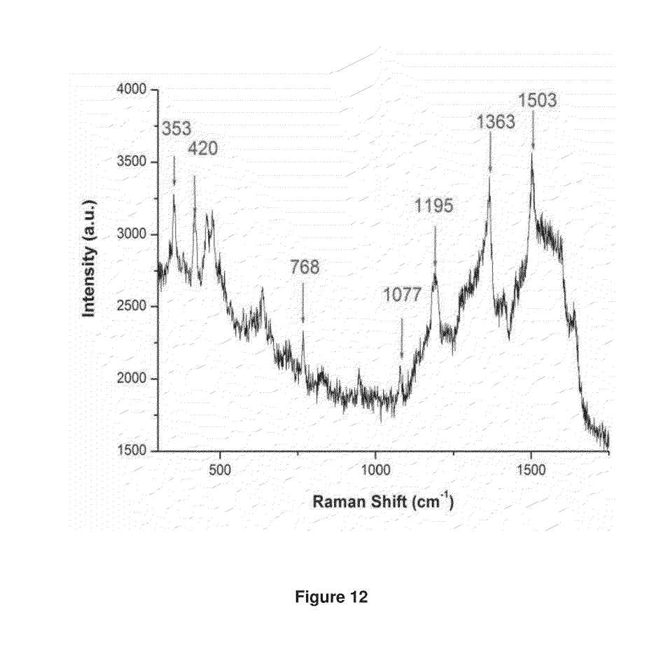

By way of example, FIG. 12 illustrates the SERS spectrum of Rhodamine 123 obtained based on SERS measurement using the optical fiber 10 having the protrusion 20 as shown in FIG. 9B. From FIG. 12, it can be seen that the SERS measurement using the optical fiber 10 produced a good SERS spectrum with clearly visible ‘fingerprints’ (as marked in FIG. 12) corresponding to the Raman characteristic wavelengths of Rhodamine 123, thereby enabling the identification/detection of Rhodamine 123.

As described above, the optical fiber 10 according to example embodiments of the present invention has a wide range of optical sensing applications, such as in-vivo sensing, remote sensing, microfluidics sensing. The optical fiber 10 with the protrusion 20 can be relatively easy to manufacture as it does not require stringent fabrication environment, such as clean room conditions. The optical fiber 10 can be easily implemented in existing apparatuses for optical sensing such as by simply replacing the conventional optical fiber. The structure or characteristic of the protrusion 20 at the sensing end of the optical fiber 20 advantageously provide an unusually high surface area-to-volume ratio thereby allowing larger capture area and stronger signal scattered from the analyte.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An optical fiber for optical sensing comprising:
a core extending along a length of the optical fiber;
a cladding surrounding the core, the cladding comprises a plurality of channels extending along the length of the optical fiber; and
a protrusion at a sensing end of the optical fiber,
wherein the protrusion has a porous structure and a curved surface.

2. The optical fiber according to claim 1, wherein the protrusion is formed by etching the sensing end of the optical fiber.

3. The optical fiber according to claim 1, wherein the protrusion comprises a plurality of micro-sized or nano-sized structures extending substantially throughout the protrusion, thereby resulting in voids being present between said micro-sized or nano-sized structures and forming the porous structure.

4. The optical fiber according to claim 3, wherein said micro-sized or nano-sized structures comprise flake-like structures densely packed across the curved surface of the protrusion.

5. The optical fiber according to claim 3, wherein the voids are in communication with the core and the channels for allowing an excitation light received through the core to reach the voids in the protrusion and for allowing a sensing signal to travel from the voids through the core and/or the channels for analysis.

6. The optical fiber according to claim 1, wherein the protrusion has a generally spherical shape.

7. The optical fiber according to claim 1, wherein the optical fiber is a photonic crystal fiber.

8. The optical fiber according to claim 6, wherein a portion of the optical fiber adjacent or proximal to the sensing end is tapered so as to partially collapse the air holes at said portion.

9. The optical fiber according to claim 1, wherein at least the protrusion is coated with a noble metal.

10. A method of manufacturing an optical fiber for optical sensing, the method comprising:
providing an optical fiber having a core extending along a length of the optical fiber and a cladding surrounding the core, the cladding comprises a plurality of channels extending along the length of the optical fiber; and
forming a protrusion at a sensing end of the optical fiber,
wherein the protrusion has a porous structure and a curved surface.

11. The method of manufacturing an optical fiber according to claim 10, wherein said forming a protrusion comprises etching the sensing end of the optical fiber.

12. The method according to claim 11, wherein said etching comprises immersing the sensing end of the optical fiber in an etching solution for a period of between about one to two minutes.

13. The method according to claim 10, wherein the protrusion comprises a plurality of micro-sized or nano-sized structures extending substantially throughout the protrusion, thereby resulting in voids being present between said micro-sized or nano-sized structures and forming the porous structure.

14. The method according to claim 13, wherein said micro-sized or nano-sized structures comprise flake-like structures densely packed across the curved surface of the protrusion.

15. The method according to claim 13, wherein the voids are in communication with the core and the channels for allowing an excitation light received through the core to reach the voids in the protrusion and for allowing a sensing signal to travel from the voids through the core and/or the channels for analysis.

16. The method according to claim 10, wherein said forming a protrusion comprises forming the protrusion having a generally spherical shape.

17. The method according to claim 10, wherein the optical fiber is a photonic crystal fiber.

18. The method according to claim 17, further comprising tapering a portion of the optical fiber adjacent or proximal to the sensing end to partially collapse the air holes at said portion.

19. The method according to claim 18, further comprising cleaving the optical fiber at a point along the tapered portion, and said forming a protrusion comprises etching the cleaved end of the optical fiber to form the protrusion.

20. The method according to claim 10, further comprising coating at least the protrusion with a noble metal.

21. A method of optically sensing an analyte of interest, comprising:
providing an optical fiber for optical sensing, the optical fiber comprising:
a core extending along a length of the optical fiber;
a cladding surrounding the core, the cladding comprises a plurality of channels extending along the length of the optical fiber; and
a protrusion at a sensing end of the optical fiber,
wherein the protrusion has a porous structure and a curved surface,
directing the protrusion at the sensing end of the optical fiber to the analyte for collecting the analyte on the protrusion;
coupling light through the core of the optical fiber and the voids of the protrusion to reach the analyte;
evaluating the analyte based on a signal scattered by the analyte received through the core and/or channels in response to said light being illuminated thereon.

22. The method of claim 21, wherein the method of optically sensing is based on Raman scattering.

23. An apparatus for optical sensing comprising a probe, wherein the probe includes an optical fiber comprising:
a core extending along a length of the optical fiber;
a cladding surrounding the core, the cladding comprises a plurality of channels extending along the length of the optical fiber; and
a protrusion at a sensing end of the optical fiber,
wherein the protrusion has a porous structure and a curved surface.

24. The apparatus according to claim 23, wherein the apparatus is based on Raman scattering.
